(19) United States
(12) Patent Application Publication
(10) Pub. No.: US 2008/0170767 A1
(43) Pub. Date: Jul. 17, 2008

(54) METHOD AND SYSTEM FOR GLEASON SCALE PATTERN RECOGNITION

(76) Inventor: Spyros A. Yfantis, Carlstadt, NJ (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/967,644

(22) Filed: Dec. 31, 2007

Related U.S. Application Data
(60) Provisional application No. 60/928,341, filed on May 8, 2007.
(60) Provisional application No. 60/880,310, filed on Jan. 12, 2007.

(51) Int. Cl. G06K 9/00

(52) U.S. Cl. 382/128

(57) ABSTRACT

A gradient is calculated for a pixel image representing a cancer area, the gradient having magnitude and direction. Local extrema of the gradients are identified, remaining pixels are zeroed. Significant gradients among the local extrema are identified, based on thresholds obtained through training. Probability distributions are calculated for the local extrema magnitudes and the significant gradient magnitudes, to form a feature vector. The feature vector is classified using a Maximum Likelihood Estimate classifier constructed from large training sets.

### CROSS-REFERENCE TO RELATED APPLICATIONS

This application claims priority to U.S. Provisional Application Ser. No. 60/928,341, filed May 8, 2007, and to U.S. Provisional Application 60/880,310, filed Jan. 12, 2007, each of which is hereby incorporated by reference.

### FIELD OF THE INVENTION

Embodiments of the invention pertain to diagnostic imaging of tissue and, in some embodiments, to identifying from image data a Gleason grading or equivalent staging measure of a cancer.

### BACKGROUND OF THE INVENTION

Even though new methods for treatment and new strategies for detection have become available, prostate cancer remains the second most common cancer that kills men in the United States. Only lung cancer causes a higher number of deaths. The numbers are telling. More than 230,000 new cases of prostate cancer were diagnosed in the U.S. during 2005.

Prostate cancer is a progressive disease and, often, different treatments are preferred at different stages. Maintaining effective, optimal treatment over the course of the disease therefore requires close, accurate monitoring of its progress.

A number of parameters are used to measure and define the cancer's state of progression. Various combinations of methods and technologies are currently used to monitor these parameters, but the current compromise between cost, accuracy, time and discomfort is viewed as not optimal by many health care professionals and by many patients as well.

The current most accepted method for monitoring the progress of prostate cancer, and the efficacy of treatment is biopsy of the prostate. Biopsy of the prostate may include transrectal ultrasound (TRUS) for visual guidance, and insertion of a spring loaded needle to remove small tissue samples from the prostate. The samples are then sent to a laboratory for pathological analysis and confirmation of a diagnosis. Generally, ten to twelve biopsy samples are removed during the procedure. Biopsy of the prostate, although one currently essential tool in the battle against prostate cancer, is invasive, is generally considered to be inconvenient, is not error free, and is expensive.

Ultrasound has been considered as a monitoring method, as it has known potential benefits. One is that the signal is non-radioactive and contains no harmful material. Another is that the equipment is fairly inexpensive and relatively easy to use.

However, although there have been attempts toward improvement, current ultrasound systems, including TRUS, are known as exhibiting what is currently considered insufficient image quality for even the most skilled urologist, using TRUS alone without biopsy, to accurately monitor and evaluate the progress of prostate cancer. cancerous regions early enough to be of practical use.

One attempt at improvement of ultrasound is described in U.S. Pat. No. 5,224,175, issued Jun. 29, 1993 to Gouge et al. (“the '175 patent”). Although the '175 patent describes reducing speckle and certain automation of detection, accuracy sufficient to classify images according to their Gleason stage is not shown.

Another attempt for improved ultrasound resolution is disclosed by International Patent Application Publication PCT WO 2006/12251, filed 16 Nov. 2006 (“the '251 PCT application”). This '251 application describes and application of chemical compounds to cause the tissue to exhibit particular features, which are analyzed and classified using neural networks and fuzzy logic.

Therefore a significant need remains for ultrasound having detection accuracy to classify cancer tissue according to its Gleason (or equivalent) scale.

### SUMMARY OF THE INVENTION

The present invention provides non-invasive classification of cancer tissue, by extracting certain features and combinations of features, having significantly improved classification resolution and accuracy compared to that provided by the current tissue imaging arts.

Embodiments of the present invention may provide accurate, economical, non-invasive classification of cancer tissue with resolution into a sufficient number of classes, and accuracy within acceptable error rates, to provide likely significant reduction in required use of invasive methods such as, for example, biopsy.

Embodiments of the present invention, by providing non-invasive classification of cancer tissue with significantly higher resolution and lower error rate than prior art non-invasive methods, at significantly lower time and cost associated with invasive methods, may provide significantly improved monitoring of cancer patients' conditions.

Embodiments of the present invention generate classification vectors by applying to training images having known pixel types the same basis functions that will be used to classify unknown pixels, to generate classification vectors optimized for detection sensitivity and minimal error.

### BRIEF DESCRIPTION OF THE DRAWINGS

FIG. 1 is a high level functional block diagram representing one example system for practicing some embodiments of the invention;

FIG. 2 shows one example ultrasound image in which certain features and characteristics may be recognized according to one or more embodiments;

FIG. 3 is one high level functional flow diagram of one method for classifying according to one embodiment a more detailed functional block diagram representing one example system according to, for example FIG. 1, for practicing some embodiments of the invention;

FIG. 4 shows one example of one sample mask according to one embodiment;

FIG. 5 graphically represents one approximation for implementing a gradient direction approximation according to one example of FIG. 4; and

FIG. 6 graphically illustrates one example one gradient direction at one example pixel, in relation to certain neighbor pixels.

### DETAILED DESCRIPTION OF ILLUSTRATIVE EMBODIMENTS

The following detailed description refers to accompanying drawings that form part of this description. The description and its drawings, though, show only examples of systems and methods embodying the invention and with certain illustrative implementations. Many alternative implementations, configurations and arrangements can be readily identified by persons of ordinary skill in the pertinent arts upon reading this description.

The following detailed description will enable persons of ordinary skill in the pertinent arts to practice the invention, by combing and applying the common knowledge necessarily possessed by such persons to this disclosure. This knowledge includes, but is not limited to, a basic working knowledge of maximum likelihood estimation (MLE) and MLE-based classification of unknown samples, including feature selection, model generation and training methods; basic working knowledge of writing machine executable code for performing medical image processing and installing the machine-executable code on a machine for performing the process according to the instructions, and a practical working knowledge of medical ultrasound scanners.

Numerals appearing in different ones of the accompanying drawings, regardless of being described as the same or different embodiments of the invention, reference functional blocks or structures that are, or may be, identical or substantially identical between the different drawings.

Unless otherwise stated or clear from the description, the accompanying drawings are not necessarily drawn to represent any scale of hardware, functional importance, or relative performance of depicted blocks.

Unless otherwise stated or clear from the description, different illustrative examples showing different structures or arrangements are not necessarily mutually exclusive. For example, a feature or aspect described reference to one embodiment may, within the scope of the appended claims, be practiced in combination with other embodiments. Therefore, instances of the phrase “in one embodiment” do not necessarily refer to the same embodiment.

Example systems and methods embodying the invention are described in reference to subject input images generated by ultrasound. Ultrasound, however, is only one example application. Systems and methods may embody and practice the invention in relation to images representing other absorption and echo characteristics such as, for example, X-ray imaging.

Example systems and methods are described in reference to example to human male prostate imaging. However, human male prostate imaging is only one illustrative example and is not intended as any limitation on the scope of systems and methods that may embody the invention. It is contemplated, and will be readily understood by persons of ordinary skill in the pertinent art that various systems and methods may embody and practice the invention in relation to other human tissue, non-human tissue, and various inanimate materials and structures.

Embodiments of the invention classify pixels and areas of pixels by described characterization as a vector in a multi-dimensional feature space, followed by classification into a class using, for example, a Maximum Likelihood Estimator model, constructed from a described training.

One described plurality of classes corresponds to the Gleason scoring system. As known in the pertinent art, Gleason scoring assesses the histologic pattern of the prostate cancer. Conventional Gleason scoring consists of two assessments—a primary (dominant) and secondary (non-dominant) grade, and both range from 1 (generally good prognosis), to 5 (generally bad prognosis). In conventional Gleason scoring, the two measurements are combined into a Gleason score which ranges from 2-10, with 2 having the best prognosis and 10 having the worst prognosis. The invention is not limited to Gleason scoring.

Example systems for practicing the invention are described in the drawings as functional block flow diagrams. The functional block diagram is segregated into depicted functional blocks to facilitate a clear understanding of example operations. The depicted segregation and arrangement of function blocks, however, is only one example representation of one example cancer tissue classification system having embodiments of the invention, and is not a limitation as to systems that may embody the invention. Further, labeled blocks are not necessarily representative of separate or individual hardware units, and the arrangement of the labeled blocks does not necessarily represent any hardware arrangement. Certain illustrative example implementations of certain blocks and combinations of blocks will be described in greater detail. The example implementations, however, may be unnecessary to practice the invention, and persons of ordinary skill in the pertinent arts will readily identify various alternative implementations based on this disclosure.

General embodiments may operate on N×M pixel images. The values of N and M may be, but are not necessarily equal. Contemplated embodiments include, but are not limited to, radial shaped images known in the conventional TRUS art.

Embodiments may operate on what is known in the pertinent art as “raw” images, meaning no image filtering performed prior to practicing the present invention. Alternatively, embodiments may be combined with conventional image filtering such as, for example, smoothing, compression, brightening and darkening. Embodiments may receive input analog-to-digital (A/D) sampled data representing a sequence of frames of an image, such as a sequence of frames representing a conventional TRUS image as displayed on a conventional display of a conventional TRUS scanner.

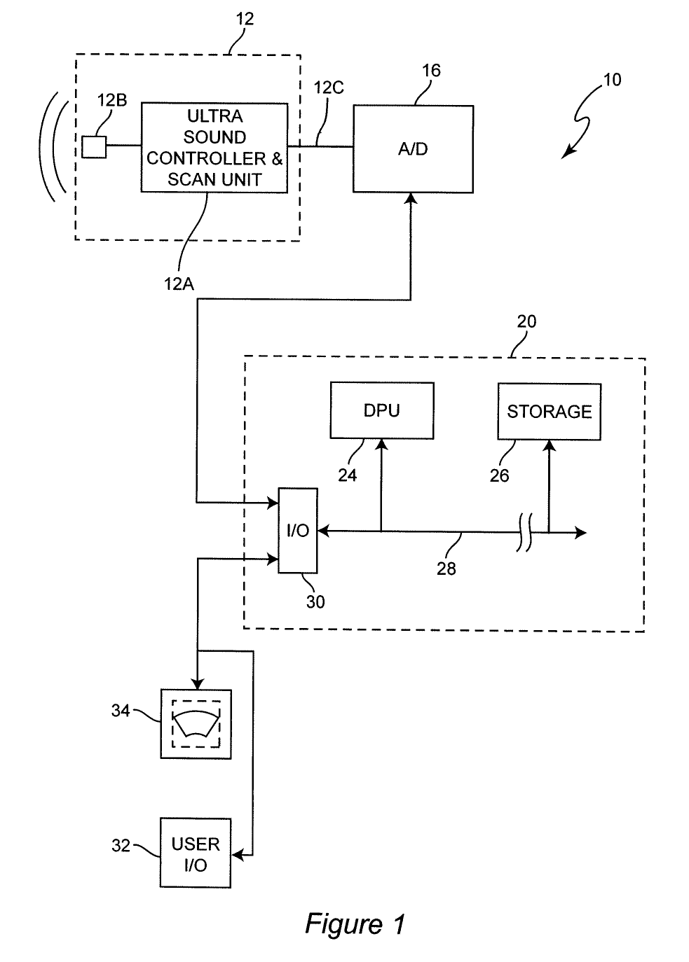

FIG. 1 shows one illustrative example system 10 to practice embodiments of the invention. Referring to FIG. 1, the example system 10 includes an ultrasound generator/receiver labeled generally as 12, having an ultrasound signal control processor 12A connected to a transmitter/receiver transducer unit 12B and having a signal output 12C. The ultrasound generator/receiver 12 may be a conventional medical ultrasound scanner such as, for example, a B&K Medical Systems Model 2202 or any of a wide range of equivalent units and system available from other vendors well known to persons of ordinary skill in the pertinent arts. The transmitter/receiver transducer unit 12B may be, for example, a B & K Model 1850 transrectal probe, or may be any of the various equivalents available from other vendors well known to persons of ordinary skill.

Selection of the power, frequency and pulse rate of the ultrasound signal may be in accordance with conventional ultrasound practice. On example is a frequency in the range of approximately 3.5 MHz to 12 MHz, and a pulse repetition or frame rate of approximately 600 to approximately 800 frames per second. Another example frequency range is up to approximately 80 MHz. As known to persons skilled in the pertinent arts, depth of penetration is much less at higher frequencies, but resolution is higher. Based on the present disclosure, a person of ordinary skill in the pertinent arts may identify applications where frequencies up to, for example, 80 MHz may be preferred.

With continuing reference to FIG. 1, the example system 10 includes an analog/digital (A/D) sampler and frame buffer 16 connecting to a data processing resource labeled generally as 20. It will be understood that the ultrasound generator/receiver 12, the A/D sampler and frame buffer 16, and the data processing resource 20 may be implemented as one integrated system or may be implemented as any architecture and arrangement of hardware units.

Referring to FIG. 1, the depicted data processing resource 20 includes a data processing unit 24 for performing instructions according to machine-executable instructions, a data storage 26 for storing image data (not shown in FIG. 1) and for storing machine executable instructions (not shown in FIG. 1), and having an internal data/control bus 28, and a data/control interface 30 connecting the internal data/control bus 28 to the A/D sampler and frame buffer 16 and to a user data input unit 32, and a display 34.

The data storage 26 may include, for example, any of the various combinations and arrangements of data storage for use with a programmable data known in the conventional arts, a solid-state random access memory (RAM), magnetic disk devices and/or optical disk devices.

The data processing resource 20 may be implemented by a conventional programmable personal computer (PC) having one or more data processing resources, such as an Intel™ Core™ or AMD™ Athlon™ processor unit or processor board, implementing the data processing unit 24, and having any standard, conventional PC data storage 26, internal data/control bus 28 and data/control interface 30. The only selection factor for choosing the PC (or any other implementation of the data processing resource 20) that is specific to the invention is the computational burden of the described feature extraction and classification operations, which is readily ascertained by a person of ordinary skill in the pertinent art based on this disclosure.

With continuing reference to FIG. 1, the display 34 is preferably, but is not necessarily, a color display. As will be understood from this disclosure, embodiments of the present may include displaying pixels at different colors, according to a color legend, to represent different Gleason scale values. Whether black and white or color, the display 34 may be a cathode ray tube (CRT), liquid crystal display (LCD), projection unit or equivalent, having a practical viewing size and preferably having a resolution of, for example, 600×800 pixels or higher.

The user data input device 32 may, for example, be a keyboard (not shown), computer mouse (not shown) that is arranged through machine-executable instructions (not shown) in the data processing resource 20 to operate in cooperation with the display 34 or another display (not shown). Alternatively, the user data input unit 32 may be included as a touch screen feature (not shown) integrated with the display 34 or with another display (not shown).

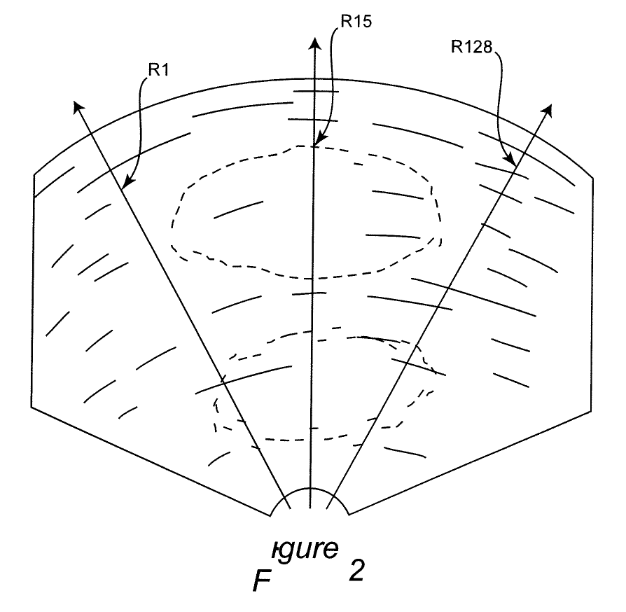

FIG. 2 shows one example ultrasound image having a cancerous area that can be accurately classified into a Gleason-1, Gleason-2, Gleason-3, Gleason-4 or Gleason-5 stage according to one or more embodiments.

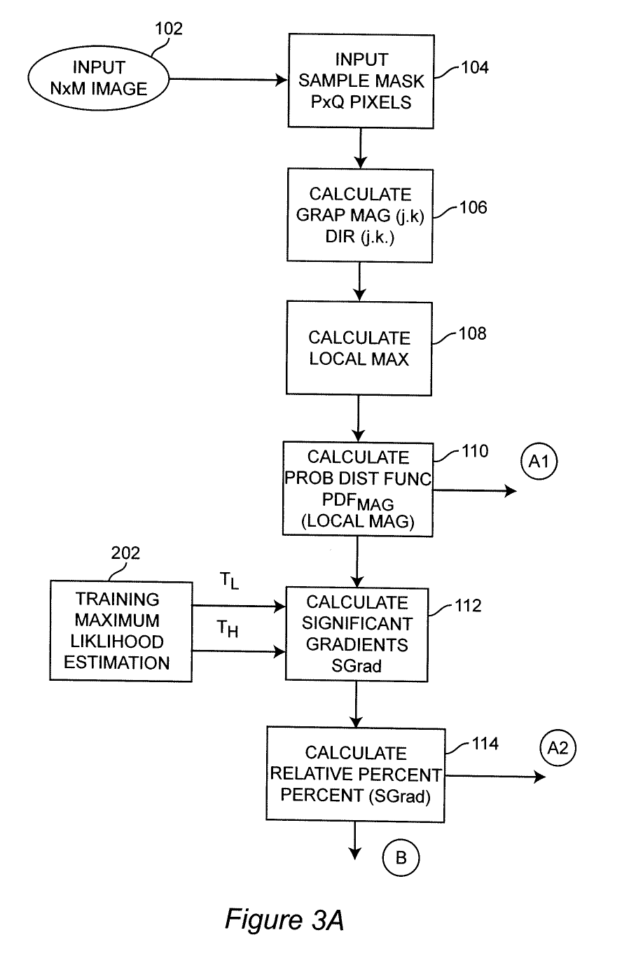

FIG. 3 is a high-level functional flow diagram describing one example method 100 according to one embodiment. Method 100 may be practiced on, for example a system according to FIG. 1. Illustrative example operations of method 100 are therefore described in reference to a system according to FIG. 1. Method 100 may be practiced, however, on any arrangement capable of performing the described operations such as, for example, a data processing resource such as the FIG. 1 resource 20 located, at least in part, remote from an ultrasound scanner generating a subject and/or training images.

Example operations in accordance with the method 100 illustrated at FIG. 3 will be described assuming, as will be described in greater detail, that the described maximum likelihood estimator (MLE) classifier models are provided to the method. Methods and guidelines for generating the classifier models, however, will be subsequently described, and further, alternative methods will also become apparent to persons of ordinary skill in the pertinent arts based on this disclosure.

The phrases “pixel magnitude” and “magnitude of the pixels” are used interchangeably and, for this example, represent the echoic nature of the tissue at the location represented by the pixel location.

Referring to FIG. 3, at 102 an N×M pixel image is input, the image having a plurality of pixels, of known j, k locations, already identified as corresponding to a cancerous tissue. The pixels are generically referenced as “identified cancer pixels.” The cancer-identified pixels may have been identified manually using, for example, a combination of TRUS and needle biopsy. The specific j, k locations of the identified cancer pixels may be stored in a file (not specifically shown) that accompanies the N×M image file. The N×M image file may, for example, be generated remote from the system, e.g., FIG. 1 system 10, on which method 100 is being practiced, and then transferred to the system (e.g., FIG. 1 system 10) via an optical disk (not shown) or via the Internet, and stored in the data storage 26 of system 10.

With continuing reference to FIG. 3, the identified cancer pixels may, alternatively, be identified by the automated cancer pixel recognition system disclosed by U.S. Provisional Application Ser. No. 60/880,310.

Potentially, a method such as 100 may operate on pixels not previously classified as cancerous. Such operation may, potentially, provide a classification of pixels according to classes comprising non-cancerous and one or more classes (e.g. Gleason levels) of cancer. Referring to FIG. 3, however, example operations of method 100 in classifying pixels will be in reference to previously identified cancer pixels.

With continuing reference to FIG. 3, at 104 a plurality of identified cancer pixels are input to one iteration. An “iteration,” in reference to FIG. 3 at 104, is intended to mean a sample sub-area or mask of identified cancer pixels such as, for example, the 11×11 mask illustrated at FIG. 3. The mask may be generically described as a P×Q mask. Referring to FIG. 3, the j, k position of each of the pixels within the 11×11 mask is along the X and Y directions, respectively. Preferably, most, if not all of the pixels within the mask are identified cancer pixels.

Referring to FIG. 3, at 106 for each pixel j, k within the mask selected at 104, the magnitude of the gradient, termed GradMag (j,k) and the direction of the gradient, termed Dir(j,k), are approximated. GradMag(j,k) measures the largest rate of change of the magnitude of the pixels at j,k, looking in all X-Y directions, and Dir(j,k) is the direction at which that largest rate of change points. The gradient, and GradMag(j,k) and Dir(j,k) can only be approximated at 106 because the image at 106 is discreet pixels, not a continuous variable image. The approximation may be generated as

$$\begin{matrix}∇ {I ( x , y )}_{x = j , y = k} = {( \frac{\partial I}{\partial X} + \frac{\partial I}{\partial Y} )}_{x = j , y = k} & ( Eq . 1 ) \\ {‖ ∇ I ( x , y ) ‖}_{x = j , y = k} = {( \sqrt{{( \frac{\partial I}{\partial X} )}^{2} + {( \frac{\partial I}{\partial Y} )}^{2}} )}_{x = j , y = k} & ( Eq . 2 )\end{matrix}$$

where GradMag (j,k) is a discrete difference approximation

GradMag(j,k)≈∥∇I(x,y)∥_{x=j,y=k} (Eq. 3)

defined as

$$GradMag ( j , k ) \approx \sqrt{\begin{matrix}{( \frac{( ( j + 1 ) , k ) - ( ( j - 1 ) , k )}{2} )}^{2} + \\ {( \frac{( j , ( k + 1 ) ) - ( j , k ( k - 1 ) )}{2} )}^{2}\end{matrix}} \qquad Eq . 4$$

Referring to FIG. 1, the 106 calculation of GradMag (j,k) may be performed on, for example, the processing resource 20 configured with appropriate machine-executable instructions (not shown) in the data storage 26. Machine-executable instructions to perform these or equivalent operations are well within the skills of a person of ordinary skill in the pertinent arts, in view of the present disclosure.

According to one aspect, the GradMag(j,k) may be further approximated by omitting the squaring and square root operations of Eq. No. 4, as follows

$$GradMag ( j , k ) \approx \frac{1}{2} ( ( ( j + 1 ) , k ) - ( j - 1 ) , k ) + ( ( j , ( k + 1 ) ) - ( j , ( k - 1 ) ) ) \qquad ( Eq . 5 )$$

As readily understood by a person of ordinary skill in the pertinent arts, the Eq. No. 5 omitting of the squaring and square root operations from Eq. No. 4 may significantly reduce computational burden, with a small, acceptable reduction in computational accuracy.

Referring to FIG. 3, the Dir(j,k) direction of the gradient at j,k may be calculated at 106 by calculating the arctan of the ratio of the Y component of the GradMag(j,k) to the X component. Referring to FIG. 1, according to one aspect an arctan operation may be performed by the data processing resource 20, by writing and storing appropriate machine-executable instructions (not shown) in the data storage 26. Machine-executable instructions to perform this, or equivalent operations are well within the skills of a person of ordinary skill in the pertinent arts, in view of this disclosure.

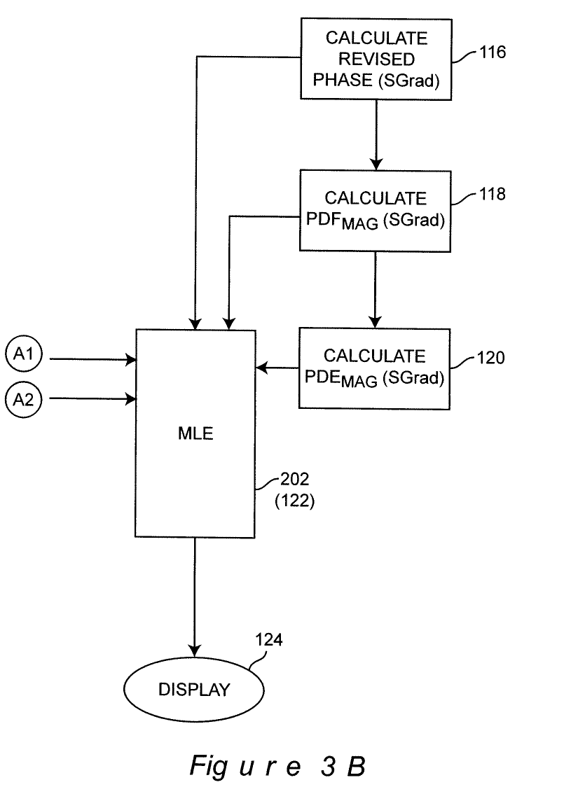

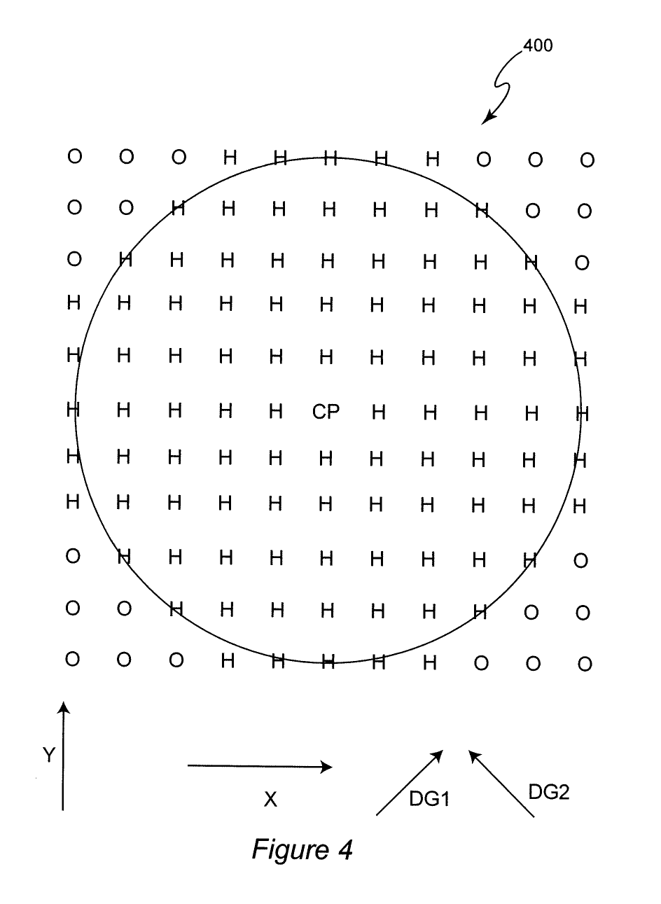

Referring to FIGS. 3 and 5, a reduction in the computational burden of calculating Dir(j,k) may be desired. One example reduction, according to one embodiment, is by approximating the arctan to increments of, for example, 45 degrees as shown in FIG. 4. According to one aspect, a table or equivalent representation of the FIG. 5 approximation mapping may be stored in, for example, the data storage 26 of the FIG. 1 system 10. As will be described in greater detail, this approximation at 45-degree increments, although not necessary, may reduce computational burden in subsequent operations.

Referring to FIG. 3, according to one embodiment after 106 calculates or approximates the magnitude and direction of the gradient at, preferably, every pixel the result is an array of gradient values, labeled for reference as GradImage, with each “pixel” being GradMag(j,k), Dir(j,k), for k=1 to P and j=1 to Q. As described in greater detail in reference to subsequent operations depicted at FIG. 3, the direction of the gradient at each pixel, Dir(j,k) will be used to define the adjacent neighbors of the j,k pixel. As further described, identifying a subject pixel's neighbor pixels is used in identifying whether the gradient at the subject pixel is a local maxima. For example, if the Dir(j,k) is 45 degrees then the j,k pixel's neighbors are the pixel at j+1, k+1 and the pixel at j−1, k−1. If Dir(j,k) is minus 45 degrees then the j,k pixel's neighbors are the pixel at j−1, k−1 and the pixel at j+1, k+1, i.e., the same neighbors as for 45 degrees but in reverse order. If Dir(j,k) is zero degrees then the j,k pixel's neighbors are j−1, k and j+1, k.

With continuing reference to FIG. 3, according to one aspect at 108 all local maxima of the GradMag(j,k) values are identified, and non-maxima entries of the GradImage are zeroed. One example operation to identify all local maxima of the GradMag(j,k) is to identify the pixel's two adjacent neighbor pixels, as described previously. After the pixel's two adjacent neighbor pixels are identified, the magnitude of the subject pixel, i.e., GradMag(j,k) is compared to the magnitude of the neighbor pixels. For example, according to one embodiment, if DirGrad(j,k) is 45 degrees the two neighbor pixels are j, k+1 and j, k−1. The 108 local maxima identifying operation would therefore compare GradMag(j,k) to GradMag(j,k+1) and GradMag(j,k−1). If GradMag(j,k)>GradMag(j,k+1) and GradMag(j,k)>GradMag(j,k−1) the GradImage pixel entry for j,k is identified as a local maxima and retained. The two neighbors, GradMag(j,k+1) and GradMag(j,k−1), are zeroed. If, on the other hand, GradMag(j,k)<GradMag(j,k+1) or GradMag(j,k)<GradMag(j,k−1) then the pixel entry for j,k is identified as not being a local maxima and, therefore, is zeroed.

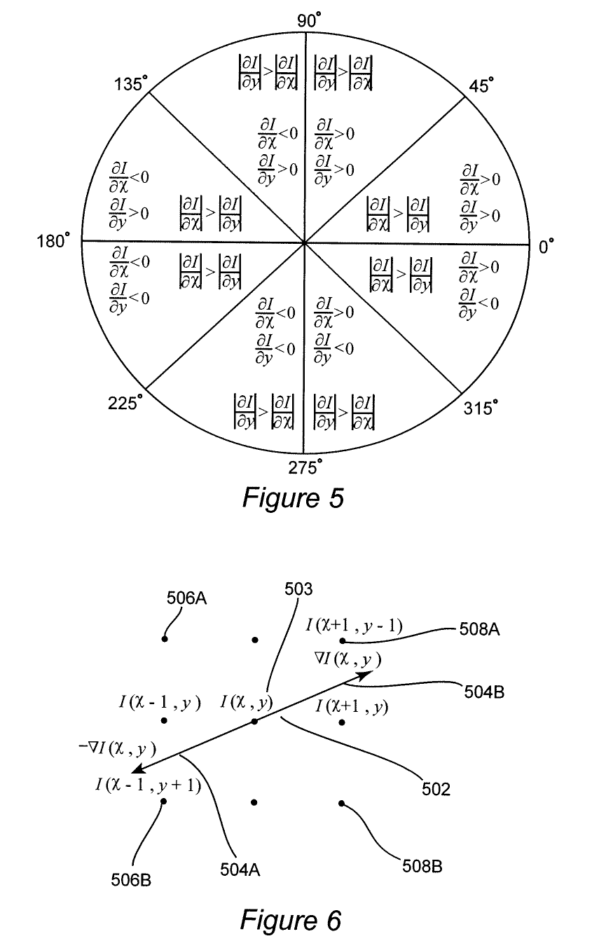

Referring to FIG. 6, another computational advantage of approximating Dir(j,k) in 45-degree increments can be seen. The line 502 in FIG. 6 is an actual arctan of the ratio of the X or j related component of GradMag(j,k) at pixel 503—and is not a multiple of 45 degrees. The neighbor “pixels,” labeled 504A and 504B, are not actual pixels; they are each between pixels. Neighbor point 504A is between pixels 506A and 506B. Neighbor point 506B is between pixels 508A and 508B. Therefore, to determine whether the GradMag(j,k) at pixel 503 is a local maxima the “magnitudes” at neighbor points 504A and 504B must each be interpolated.

Referring to FIG. 3, according to one embodiment, the local maxima operation 108 continues until all pixels of the GradImage array are inspected, and either identified as local maxima or zeroed.

In accordance with one embodiment, the processing result upon completion of 108 identifying all local maxima is the remaining entries of the GradImage array, labeled, for reference in this disclosure, as LocalMax. The LocalMax array has what are termed in this disclosure as “significant” gradients, and what are termed in this disclosure as “artifact” gradients. The artifact gradient entries will be removed, in this example method 100, at subsequent operational block 114.

Referring again to FIG. 3, the example method 100 at 110 calculates the probability distribution function of the gradient magnitudes in the LocalMax array, labeled for reference in this disclosure as PDF_{MAG} (LocalMax). As will be understood from the entirety of this disclosure, the example method 100 at 108 thereby extracts, and subsequently exploits, information in the LocalMax array that, regardless of the artifact pixels, the invention identifies as one feature for the maximum likelihood estimation classification performed at subsequent blocks. Referring to FIG. 1, according to one aspect the calculation of PDF_{MAG} (LocalMax) an arctan operation may be performed by the data processing resource 20, by writing and storing appropriate machine-executable instructions (not shown) in the data storage 26. Machine-executable instructions to perform this, or equivalent operations are well within the skills of a person of ordinary skill in the pertinent arts, in view of this disclosure.

Referring to FIG. 3, according to one aspect operational block 112 identifies the significant gradient entries in the LocalMax array of local maxima gradient values generated at 108, and deletes the artifact gradient entries, based on a preferably pre-stored floor threshold T_{L} and a high or absolute qualifier threshold T_{H}. According to one aspect, formulation of the floor threshold T_{L} and the absolute qualifier threshold T_{H} is, preferably, based on a large set of training images, and will be later described in greater detail. The artifact gradient entries that are removed by the low threshold T_{L} and the absolute qualifier threshold T_{H} may be caused, at least in part, by gradients having a magnitude alternating above and below a threshold.

Referring to FIG. 3, according to one aspect the operational block 112 removes the artifact entries in the array of local maxima gradients LocalMax by unconditionally deleting the entries below the floor threshold T_{L}, unconditionally qualifying as significant gradients all gradients with a GradMag(j,k) value above T_{H}, and, preferably, performing a hysteresis-based elimination on all gradient entries in the LocalMax array having a magnitude GradMag(j,k) between T_{L} and T_{H}.

With continuing reference to FIG. 3, in an example hysteresis elimination according to one aspect, the operational block 112 qualifies or removes remaining, or conditional entries in the LocalMax array by searching gradient paths or lines from the conditional pixel. According to the one aspect, if the searching connects to a pixel having a gradient magnitude equal to or greater than T_{H} then the gradient associated conditional pixel is qualified as a significant gradient. If the searching connects to a pixel having a gradient magnitude less than T_{L} then the conditional pixel is identified as having an artifact gradient and, therefore, is deleted from LocalMax.

The above-described aspect or hysteresis-based elimination of artifacts provides significant improvement in noise reduction and MLE classification performance. One particular example is that the likelihood of artifacts is dramatically reduced because the line segment points must fluctuate above the T_{H} and T_{L} thresholds which, based on empirical observation in practicing the invention and without any statement of theoretical conclusion, appears to be a significantly irregular and improbable characteristic of gradients magnitudes of pixels corresponding to cancerous tissue.

The specific values of T_{L} and T_{H} may be determined empirically such as, for example, by studying large sets of pixels corresponding to cancer tissue known with particularity and acceptable certainty as being, for example, Gleason-3, Gleason-4 and Gleason-5.

Without any statement of theoretical conclusion, it was observed in practicing the invention that the specific values of T_{L} and T_{H} may be Gleason scale dependent. Accordingly, it is contemplated that according to one or embodiments, an image input at 102 of FIG. 3 may be analyzed and classified multiple with iterations (not shown), having different values of T_{L} and T_{H}. Alternatively, according to one aspect, multiple values of T_{L} and T_{H} may be prestored in, for example, the data storage 26 of FIG. 1.

Referring again to FIG. 1, according to one aspect after 112 completes the above-described or equivalent reduction or pruning of the LocalMax array, based on T_{L} and T_{H}, the result is an array of significant gradients, which may be labeled for reference generally as SGrad and specifically as SGgrad (j,k), where the entry is zero or null for many values of j and k.

With continuing reference to FIG. 3, according to one aspect, after generation of the SGrad array of significant gradients, 114 calculates the relative percent of significant gradients, i.e., a percentage or other measure representing the ratio (in terms of quantity) of significant gradients in SGgrad to the number of pixels in the P×Q sample mask. This ratio is labeled, for reference in this disclosure, as Percent(SGgrad).

Referring to FIG. 3, according to one aspect at 116 another calculation of the phase angle for each significant gradient SGgrad may be performed. As previously described in reference to FIG. 5, a phase angle for all of the significant gradients comprising SGgrad was approximated at 106. However, calculation of the phase angle more accurately than the 106 approximation (e.g., increments of 45 degrees) may be desired. One example implementation is the FIG. 1, the data processing resource 20, configured with appropriate machine-executable instructions (not shown) in the data storage 26.

Referring to FIG. 3, according to one aspect operational block 118 calculates the probability distributions, labeled for reference in this disclosure as PDF_{MAG} (SGgrad), of the magnitudes of the generated significant gradients SGrad, and 120 calculates the probability distributions, labeled for reference in this disclosure as PDF_{ANG} (SGgrad) of the gradient angles or phases of the generated significant gradients SGrad. The operational blocks 118 and 120 may be combined and are shown separate only for purposes separately of describing their respective operations.

Referring to FIG. 3, according to one aspect, at 122 the area of the relative area of the cancerous region of the input image, described in reference to operational block 102, to the total area of the entire image is calculated and stored. It will be understood that 122 is not necessarily performed in the order relative to the other operational blocs of FIG. 3, and may be performed at, for example, 102 or 104, or may be pre-calculated and stored with the input N×M image at 102.

With continuing reference to FIG. 3, according to one aspect, upon conclusion of all operations represented by functional blocks 102 through 122 has been formed, comprising: the probability distribution function for the LocalMax gradients, PDF_{MAG}(LocalMax) generated at 110, the percent significant gradients Percent(SGgrad) generated at 114, the probability distribution function for the significant gradients, PDF_{MAG} (SGgrad), generated at 118, and the probability distribution function for the phase angles of the significant gradients, PDF_{ANG} (SGgrad), generated at 120.

Referring to FIG. 3, this feature vector, referenced for this description as Features(PixelBlockPQ) is applied at 122 to identify the maximum likelihood estimate (MLE) of the Gleason of the cancer tissue corresponding to the block. The models constructed at 202 were preferably based on large sample sets of images having Gleason-1, Gleadon-2, Gleason-3, Gleason-4 and Gleason-5 cancer tissue. The described extractions at 102 through 118, generating the particular described Features(PixelBlockPQ) vector, further combined with the MLE training and MLE classifier at 122, efficiently exploits the characterizing features of Gleason dependent tissue, and provides the medical field with a powerful new technology for treatment of prostate cancer.

With continuing reference to FIG. 3, after the MLE at 122 classifies the subject P×Q mask of cancer-identified pixels at input at 104 the method may go to 124 and display the result.

While certain embodiments and features of the invention have been illustrated and described herein, many modifications, substitutions, changes, and equivalents will occur to those of ordinary skill in the art, and the appended claims cover all such modifications and changes as fall within the spirit of the invention.

We hereby claim:

1. A method for classifying pixels of a pixel image representing a substance into one of multiple classes, comprising:
providing a maximum likelihood estimation model for each of a plurality of cancer conditions, each model having a first gradient probability distribution parameter, a cancerous region area parameter, a significant gradient magnitude distribution parameter, and a gradient phase distribution;
providing a pixel array representing a tissue having a cancer;
generating an array of gradient values, each value having a gradient magnitude and a gradient angle, each value corresponding to a pixel array;
generating an array of local maxima gradients, each corresponding to one value of the array of gradient values, and each indicating a magnitude of a pixel of the pixel array having a relative magnitude larger than a neighbor pixel;
generating a first gradient probability distribution function, based on a cancerous tissue, and based on said teacher basis;
generating an array of significant gradients, based on the array of gradient values and on a given low threshold and a given high threshold;
generating a phase distribution, representing a probability distribution of the gradient angle of said array of significant gradients;
generating a significant gradient probability distribution function characterizing a probability distribution of the magnitude of the significant gradients;
performing a maximum likelihood estimate, based on said first gradient, said probability distribution function, said first gradient probability distribution said cancerous tissue area value, and said phase distribution, to maximize the probability of the subject pixel being in one, and not all, classification.

2. The method of claim 1, further comprising generating a significant gradient percentage data based on a comparative population of said significant gradients to the population of said pixels, wherein said performing said maximum likelihood estimate is further based on said generated significant gradient percentage data.

3. The method of claim 1, wherein the provided maximum likelihood estimation model includes prostate cancer conditions, said conditions including a plurality of Gleason scores, and wherein said performing a maximum likelihood estimate generates an estimate of the Gleason score of the tissue corresponding to the pixel being classified.

4. The method of claim 1, wherein said providing a maximum likelihood estimation model for each of a plurality of cancer conditions includes providing a large sample set of images having known cancerous regions having a known first Gleason scale score:
i) selecting an image area of Q×R pixels from one of said images, the selected image area having a known value of the area of tissue having the known first Gleason scale score, and a known value of the area of tissue having a non-cancerous condition;
ii) generating an array of gradient values for each pixel in the Q×R array, each value having a gradient magnitude and a gradient angle;
iii) generating an array of local maxima gradients, each corresponding to one value of the array of gradient values, and each indicating a magnitude of a pixel of the pixel array having a relative magnitude larger than a neighbor pixel;
iv) generating a first gradient probability distribution function based on the array of local maxima gradients;
v) initializing an upper cut-off threshold T_{U} and a lower cutoff threshold T_{L};
vi) generating an array of significant gradients, based on the array of gradient values and on said upper cut-off threshold T_{U} and lower cutoff threshold T_{L};
vii) generating a significant gradient quantity data, based on a comparative population of said significant gradients to the population of said pixels in said P×Q array;
viii) generating a phase distribution, representing a probability distribution of the gradient angle of said array of significant gradients;
ix) generating a significant gradient probability distribution function characterizing a probability distribution of the magnitude of the significant gradients; and
x) generating a first training vector based on said first gradient probability distribution, said significant gradient probability distribution function, said phase distribution function, and said significant gradient quantity data;
xi) selecting another image area of P×Q pixels having a known value of the area of tissue having the known first Gleason scale score, and a known value of the area of tissue having a non-cancerous condition:
xii) repeating (ii) through (xi) a predetermined number of time to generate a predetermined quantity of first training vectors; and
xiii) averaging the quantity of first training vectors to generate a first centroid, wherein said first centroid defines a first of said classes.

5. The method of claim 4, wherein said providing a maximum likelihood estimation model for each of a plurality of cancer conditions includes providing a large sample set of images having known cancerous regions having a known second Gleason scale score:
xiv) selecting an image area of Q×R pixels from one of said images, the selected image area having a known value of the area of tissue having the known second Gleason scale score, and a known value of the area of tissue having a non-cancerous condition;
xv) generating an array of gradient values for each pixel in the Q×R array, each value having a gradient magnitude and a gradient angle;
xvi) generating an array of local maxima gradients, each corresponding to one value of the array of gradient values, and each indicating a magnitude of a pixel of the pixel array having a relative magnitude larger than a neighbor pixel;
xvii) generating a first gradient probability distribution function based on the array of local maxima gradients;
xviii) initializing an upper cut-off threshold T_{U} and a lower cutoff threshold T_{L};
xix) generating an array of significant gradients, based on the array of gradient values and on said upper cut-off threshold T_{U} and lower cutoff threshold T_{L};
xx) generating a significant gradient quantity data, based on a comparative population of said significant gradients to the population of said pixels in said P×Q array;
xxi) generating a phase distribution, representing a probability distribution of the gradient angle of said array of significant gradients;
xxii) generating a significant gradient probability distribution function characterizing a probability distribution of the magnitude of the significant gradients; and
xxiii) generating a first training vector based on said first gradient probability distribution, said significant gradient probability distribution function, said phase distribution function, and said significant gradient quantity data;
xxiv) selecting another image area of P×Q pixels having a known value of the area of tissue having the known second Gleason scale score, and a known value of the area of tissue having a non-cancerous condition:
xxv) repeating (xv) through (xvi) a predetermined number of time to generate a predetermined quantity of second training vectors; and
xxvi) averaging the quantity of second training vectors to generate a second centroid, wherein said second centroid defines a second of said classes.

6. The method of claim 5, further comprising an optimization of the cut-off threshold T_{U} and a lower cutoff threshold T_{L} image area, comprising:
a testing, comprising:
inputting a plurality of first test image areas of Q×R pixels, each having a known value of the area of tissue having the known first Gleason scale score, and a known value of the area of tissue having a non-cancerous condition,
inputting a plurality of second test image areas of Q×R pixels, each having a known value of the area of tissue having the known second Gleason scale score, and a known value of the area of tissue having a non-cancerous condition,
classifying the first test images and the second test images against the maximum likelihood model having said first centroid and said second centroid to generate an error measure;
changing at least one of said cut-off threshold T_{U} and a lower cutoff threshold T_{L} image area and repeating (i) though (xxvi) to generate another first centroid and another second centroid;
repeating said testing to generate another test measure; and
repeating said changing and said repeating said testing until a given optimum error is identified.

7. A machine-readable storage medium to provide instructions, which if executed on the machine performs operations comprising:
providing a maximum likelihood estimation model for each of a plurality of cancer conditions, each model having a first gradient probability distribution parameter, a cancerous region area parameter, a significant gradient magnitude distribution parameter, and a gradient phase distribution;
providing a pixel array representing a tissue having a cancer;
generating an array of gradient values, each value having a gradient magnitude and a gradient angle, each value corresponding to a pixel array;
generating an array of local maxima gradients, each corresponding to one value of the array of gradient values, and each indicating a magnitude of a pixel of the pixel array having a relative magnitude larger than a neighbor pixel;
generating a first gradient probability distribution function, based on a cancerous tissue, and based on said teacher basis;
generating an array of significant gradients, based on the array of gradient values and on a given low threshold and a given high threshold;
generating a phase distribution, representing a probability distribution of the gradient angle of said array of significant gradients;
generating a significant gradient probability distribution function characterizing a probability distribution of the magnitude of the significant gradients;
performing a maximum likelihood estimate, based on said first gradient, said probability distribution function, said first gradient probability distribution said cancerous tissue area value, and said phase distribution, to maximize the probability of the subject pixel being in one, and not all, classification.

8. The machine-readable storage medium of claim 7, to provide instructions, which if executed on the machine, further performs operations comprising: generating a significant gradient percentage data based on a comparative population of said significant gradients to the population of said pixels, wherein said performing said maximum likelihood estimate is further based on said generated significant gradient percentage data.

9. The machine-readable storage medium of claim 7, to provide instructions, which if executed on the machine, further performs operations comprising providing the maximum likelihood estimation model to include prostate cancer conditions, said conditions including a plurality of Gleason scores, and wherein said performing a maximum likelihood estimate generates an estimate of the Gleason score of the tissue corresponding to the pixel being classified.

10. The machine-readable storage medium of claim 7, to provide instructions, which if executed on the machine, further performs operations comprising:
i) selecting an image area of Q×R pixels from one of said images, the selected image area having a known value of the area of tissue having the known first Gleason scale score, and a known value of the area of tissue having a non-cancerous condition;
ii) generating an array of gradient values for each pixel in the Q×R array, each value having a gradient magnitude and a gradient angle;
iii) generating an array of local maxima gradients, each corresponding to one value of the array of gradient values, and each indicating a magnitude of a pixel of the pixel array having a relative magnitude larger than a neighbor pixel;
iv) generating a first gradient probability distribution function based on the array of local maxima gradients;
v) initializing an upper cut-off threshold T_{U} and a lower cutoff threshold T_{L};
vi) generating an array of significant gradients, based on the array of gradient values and on said upper cut-off threshold T_{U} and lower cutoff threshold T_{L};
vii) generating a significant gradient quantity data, based on a comparative population of said significant gradients to the population of said pixels in said P×Q array;
viii) generating a phase distribution, representing a probability distribution of the gradient angle of said array of significant gradients;
ix) generating a significant gradient probability distribution function characterizing a probability distribution of the magnitude of the significant gradients; and
x) generating a first training vector based on said first gradient probability distribution, said significant gradient probability distribution function, said phase distribution function, and said significant gradient quantity data;
xi) selecting another image area of P×Q pixels having a known value of the area of tissue having the known first Gleason scale score, and a known value of the area of tissue having a non-cancerous condition:
xii) repeating (ii) through (xi) a predetermined number of time to generate a predetermined quantity of first training vectors; and
xiii) averaging the quantity of first training vectors to generate a first centroid, wherein said first centroid defines a first of said classes.

11. The machine-readable storage medium of claim 10, to provide instructions, which if executed on the machine, further performs operations comprising:
xiv) selecting an image area of Q×R pixels from one of said images, the selected image area having a known value of the area of tissue having the known second Gleason scale score, and a known value of the area of tissue having a non-cancerous condition;
xv) generating an array of gradient values for each pixel in the Q×R array, each value having a gradient magnitude and a gradient angle;
xvi) generating an array of local maxima gradients, each corresponding to one value of the array of gradient values, and each indicating a magnitude of a pixel of the pixel array having a relative magnitude larger than a neighbor pixel;
xvii) generating a first gradient probability distribution function based on the array of local maxima gradients;
xviii) initializing an upper cut-off threshold T_{U} and a lower cutoff threshold T_{L};
xix) generating an array of significant gradients, based on the array of gradient values and on said upper cut-off threshold T_{U} and lower cutoff threshold T_{L};
xx) generating a significant gradient quantity data, based on a comparative population of said significant gradients to the population of said pixels in said P×Q array;
xxi) generating a phase distribution, representing a probability distribution of the gradient angle of said array of significant gradients;
xxii) generating a significant gradient probability distribution function characterizing a probability distribution of the magnitude of the significant gradients; and
xxiii) generating a first training vector based on said first gradient probability distribution, said significant gradient probability distribution function, said phase distribution function, and said significant gradient quantity data;
xxiv) selecting another image area of P×Q pixels having a known value of the area of tissue having the known second Gleason scale score, and a known value of the area of tissue having a non-cancerous condition:
xxv) repeating (xv) through (xvi) a predetermined number of time to generate a predetermined quantity of second training vectors; and
xxvi) averaging the quantity of second training vectors to generate a second centroid, wherein said second centroid defines a second of said classes.

12. The machine-readable storage medium of claim 11, to provide instructions, which if executed on the machine, further performs operations comprising:
a testing, comprising:
inputting a plurality of first test image areas of Q×R pixels, each having a known value of the area of tissue having the known first Gleason scale score, and a known value of the area of tissue having a non-cancerous condition,
inputting a plurality of second test image areas of Q×R pixels, each having a known value of the area of tissue having the known second Gleason scale score, and a known value of the area of tissue having a non-cancerous condition,
classifying the first test images and the second test images against the maximum likelihood model having said first centroid and said second centroid to generate an error measure;
changing at least one of said cut-off threshold T_{U} and a lower cutoff threshold T_{L} image area and repeating (i) though (xxvi) to generate another first centroid and another second centroid;
repeating said testing to generate another test measure; and
repeating said changing and said repeating said testing until a given optimum error is identified.

13. An ultrasound image recognition system comprising: an ultrasound scanner having an RF echo output, an analog to digital (A/D) frame sampler for receiving the RF echo output, a machine arranged for executing machine-readable instructions, and a machine-readable storage medium to provide instructions, which if executed on the machine, perform operations comprising:
providing a maximum likelihood estimation model for each of a plurality of cancer conditions, each model having a first gradient probability distribution parameter, a cancerous region area parameter, a significant gradient magnitude distribution parameter, and a gradient phase distribution;
providing a pixel array representing a tissue having a cancer;
generating an array of gradient values, each value having a gradient magnitude and a gradient angle, each value corresponding to a pixel array;
generating an array of local maxima gradients, each corresponding to one value of the array of gradient values, and each indicating a magnitude of a pixel of the pixel array having a relative magnitude larger than a neighbor pixel;
generating a first gradient probability distribution function, based on a cancerous tissue, and based on said teacher basis;
generating an array of significant gradients, based on the array of gradient values and on a given low threshold and a given high threshold;
generating a phase distribution, representing a probability distribution of the gradient angle of said array of significant gradients;
generating a significant gradient probability distribution function characterizing a probability distribution of the magnitude of the significant gradients;
performing a maximum likelihood estimate, based on said first gradient, said probability distribution function, said first gradient probability distribution said cancerous tissue area value, and said phase distribution, to maximize the probability of the subject pixel being in one, and not all, classification.

14. The system of claim 13, wherein the machine readable storage medium provides instructions, which if executed on the machine, further performs operations comprising:
i) selecting an image area of Q×R pixels from one of said images, the selected image area having a known value of the area of tissue having the known first Gleason scale score, and a known value of the area of tissue having a non-cancerous condition;
ii) generating an array of gradient values for each pixel in the Q×R array, each value having a gradient magnitude and a gradient angle;
iii) generating an array of local maxima gradients, each corresponding to one value of the array of gradient values, and each indicating a magnitude of a pixel of the pixel array having a relative magnitude larger than a neighbor pixel;
iv) generating a first gradient probability distribution function based on the array of local maxima gradients;
v) initializing an upper cut-off threshold T_{U} and a lower cutoff threshold T_{L};
vi) generating an array of significant gradients, based on the array of gradient values and on said upper cut-off threshold T_{U} and lower cutoff threshold T_{L};
vii) generating a significant gradient quantity data, based on a comparative population of said significant gradients to the population of said pixels in said P×Q array;
viii) generating a phase distribution, representing a probability distribution of the gradient angle of said array of significant gradients;
ix) generating a significant gradient probability distribution function characterizing a probability distribution of the magnitude of the significant gradients; and
x) generating a first training vector based on said first gradient probability distribution, said significant gradient probability distribution function, said phase distribution function, and said significant gradient quantity data;
xi) selecting another image area of P×Q pixels having a known value of the area of tissue having the known first Gleason scale score, and a known value of the area of tissue having a non-cancerous condition:
xii) repeating (ii) through (xi) a predetermined number of time to generate a predetermined quantity of first training vectors; and
xiii) averaging the quantity of first training vectors to generate a first centroid, wherein said first centroid defines a first of said classes.
